(19) United States
(12) Patent Application Publication
(10) Pub. No.: US 2026/0102752 A1
(43) Pub. Date: Apr. 16, 2026

(54) FLOW REACTOR

(71) Applicant: Panasonic Intellectual Property Management Co., Ltd., Osaka (JP)

(72) Inventors: HIROAKI YOSHIDA, Osaka (JP); TAICHI NAKAMURA, Osaka (JP); YOSHIE TAKAHASHI, Osaka (JP); JUNJI HOSOKAWA, Osaka (JP)

(21) Appl. No.: 19/351,363

(22) Filed: Oct. 7, 2025

(30) Foreign Application Priority Data
Oct. 15, 2024 (JP) 2024-180299

(51) Int. Cl. B01J 19/00; B01F 23/45; B01F 33/30; B01F 33/3011; B01F 101/00; B01J 14/00; B01J 19/06; B01J 19/24

(52) U.S. Cl. CPC B01J 19/0093; B01F 23/45; B01F 33/3011; B01F 33/30351; B01J 14/00; B01J 19/06; B01J 19/244; B01F 2101/2204; B01F 2215/0427; B01F 2215/0431; B01J 2219/0084; B01J 2219/00855; B01J 2219/0086; B01J 2219/00889; B01J 2219/00894

(57) ABSTRACT

A flow reactor that mixes a first and a second fluid, wherein the first fluid flows toward a first tip between an inner wall of a first inner tubular portion and an outer wall of a second inner tubular portion, the second fluid flows toward a second tip inside the second inner tubular portion, a third fluid having low affinity for the first and the second fluid flows toward a downstream end between an outer wall of the first inner tubular portion and an inner wall of an outer tubular portion, the second tip of the second inner tubular portion does not protrude further to the side of the downstream end than the first tip of the first inner tubular portion, and the first tip is located closer to the side of the upstream end than the downstream end when viewed from a direction orthogonal to the flow direction.

### BACKGROUND

### 1. Technical Field

The present disclosure relates to a flow reactor, and more specifically, to a flow reactor that mixes and transports a plurality of fluids.

### 2. Description of the Related Art

A fine particle production method using a reaction in a liquid phase is industrially expected because a synthesis process is simpler than that in a fine particle production method using a reaction in a gas phase such as a sputtering method, and mass production can be performed at a time.

As a method of precisely and continuously performing reaction in a liquid phase, there is a method called microflow synthesis. The microflow synthesis is a synthesis method in which a plurality of unit operations such as mixing and heating are continuously performed in a single continuous process, and has high throughput compared to a synthesis method in which each unit operation is discontinuously performed in order by using a reaction pot called batch synthesis. For this reason, by applying the microflow synthesis to production of a fine particle and polymer, it is expected to efficiently produce a material having a particle size, a molecular weight, and a composition controlled with high accuracy.

In the microflow synthesis, generated fine particles may settle and adhere to and deposit on an inner wall of a flow path, which may cause flow path blockage. For this reason, in order to stably produce fine particles, it is required to prevent flow path blockage due to adhesion of a product. As a flow reactor that prevents flow path blockage due to adhesion of a product, for example, there is a mixer for two-liquid mixing disclosed in PTL 1.

### CITATION LIST

### Patent Literature

PTL 1: Unexamined Japanese Patent Publication No. 2017-136558

### SUMMARY

In order to achieve the above object, a flow reactor according to one aspect of the present disclosure is a flow reactor that mixes a first fluid and a second fluid, the flow reactor including an outer tubular portion in which a plurality of fluids flow from an upstream end to a downstream end in a flow direction, a first inner tubular portion disposed in a part of the inside of the outer tubular portion and fluidly communicating with the outer tubular portion at a first tip of the first inner tubular portion, and a second inner tubular portion disposed in a part of the inside of the first inner tubular portion and fluidly communicating with the first inner tubular portion at a second tip of the second inner tubular portion, in which the first fluid flows toward the first tip in a flow direction between an inner wall of the first inner tubular portion and an outer wall of the second inner tubular portion, the second fluid flows toward the second tip in the flow direction inside the second inner tubular portion, the third fluid having low affinity for the first fluid and the second fluid flows toward the downstream end in the flow direction between an outer wall of the first inner tubular portion and an inner wall of the outer tubular portion, the second tip does not protrude further to the side of the downstream end than the first tip, and the first tip is located closer to the side of the upstream end than the downstream end when viewed from a direction orthogonal to the flow direction.

### BRIEF DESCRIPTION OF THE DRAWINGS

FIG. 1 is a schematic cross-sectional view illustrating a configuration of a microflow synthesis apparatus according to a first exemplary embodiment;

FIG. 2 is a schematic cross-sectional view illustrating a configuration of a flow reactor according to the first exemplary embodiment;

FIG. 3 is a schematic cross-sectional view of an A-A plane of the flow reactor of FIG. 2;

FIG. 4A is a view for explaining an effect of a flow field of a segment flow in the flow reactor of the present disclosure, and is a conceptual diagram showing a flow field in which a segment flow is not formed;

FIG. 4B is a view for explaining an effect of a flow field of a segment flow in the flow reactor of the present disclosure, and is a conceptual diagram showing a flow field in which a segment flow is formed; and

FIG. 5 is a conceptual diagram for explaining an effect of surface tension of a segment flow in the flow reactor of the present disclosure.

### DETAILED DESCRIPTIONS

The mixer for two-liquid mixing of PTL 1 includes a joint member having a double tube structure and a static mixer member connected to the joint member, and is configured such that two liquids flowing out from the double-tube joint member flow into the static mixer member and are mixed.

However, when the mixer for two-liquid mixing of PTL 1 is applied to a process such as a crystallization reaction in which a solid component is immediately generated after a plurality of fluids are mixed, for example, as the mixed fluid flows in a flow path, a product adheres to and is deposited on an inner wall of the flow path, and there is a problem that the flow path is blocked. For this reason, in microflow synthesis, there is still room for improvement in a conventional flow reactor that prevents flow path blockage.

In view of the above, the present disclosure solves the above-described conventional problem, and an object of the present disclosure is to provide a flow reactor capable of suppressing adhesion of a product to a flow path.

According to a first aspect of the present disclosure, there is provided a flow reactor that mixes a first fluid and a second fluid, the flow reactor including an outer tubular portion in which a plurality of fluids flow from an upstream end to a downstream end in a flow direction, a first inner tubular portion disposed in a part of the inside of the outer tubular portion and fluidly communicating with the outer tubular portion at a first tip of the first inner tubular portion, and a second inner tubular portion disposed in a part of the inside of the first inner tubular portion and fluidly communicating with the first inner tubular portion at a second tip of the second inner tubular portion, in which the first fluid flows toward the first tip in a flow direction between an inner wall of the first inner tubular portion and an outer wall of the second inner tubular portion, the second fluid flows toward the second tip in the flow direction inside the second inner tubular portion, the third fluid having low affinity for the first fluid and the second fluid flows toward the downstream end in the flow direction between an outer wall of the first inner tubular portion and an inner wall of the outer tubular portion, the second tip does not protrude further to the side of the downstream end than the first tip, and the first tip is located closer to the side of the upstream end than the downstream end when viewed from a direction orthogonal to the flow direction.

According to this aspect, adhesion of a product to a flow path can be suppressed.

According to a second aspect of the present disclosure, there is provided the flow reactor according to the first aspect, in which a gap is provided between the first tip and the second tip when viewed from a direction orthogonal to a flow direction, and 0 mm≤d<50 mm is satisfied, where d denotes a length of the gap along the flow direction.

According to a third aspect of the present disclosure, there is provided the flow reactor according to the first or second aspect, in which an outer wall surface of the first inner tubular portion has liquid repellency.

According to a fourth aspect of the present disclosure, there is provided the flow reactor according to any one of the first to third aspects, in which an inner diameter of the first inner tubular portion ranges from 0.5 mm to 20 mm inclusive.

According to a fifth aspect of the present disclosure, there is provided the flow reactor according to any one of the first to fourth aspects, in which an inner wall surface of the outer tubular portion has liquid repellency.

Note that by appropriately combining discretionary exemplary embodiments among the various exemplary embodiments described above, effects of the exemplary embodiments can be achieved.

An exemplary embodiment will be described in detail below with reference to the drawings as appropriate. However, unnecessarily detailed description may be omitted. For example, a detailed description of an already well-known matter and a duplicated description of substantially the same configuration may be omitted. This is to avoid unnecessary redundancy in the following description and to facilitate understanding of those skilled in the art.

Hereinafter, a flow synthesis apparatus according to an exemplary embodiment of the present disclosure will be described with reference to the drawings. The accompanying drawings and the following description are provided for those skilled in the art to fully understand the present disclosure, and are not intended to limit the subject matter described in the claims in any way. Further, in each of the drawings, elements are illustrated exaggeratedly in order to facilitate the description. Note that, in the drawings, substantially the same members are denoted by the same reference numerals.

### First Exemplary Embodiment

### <Configuration of Microflow Synthesis Apparatus>

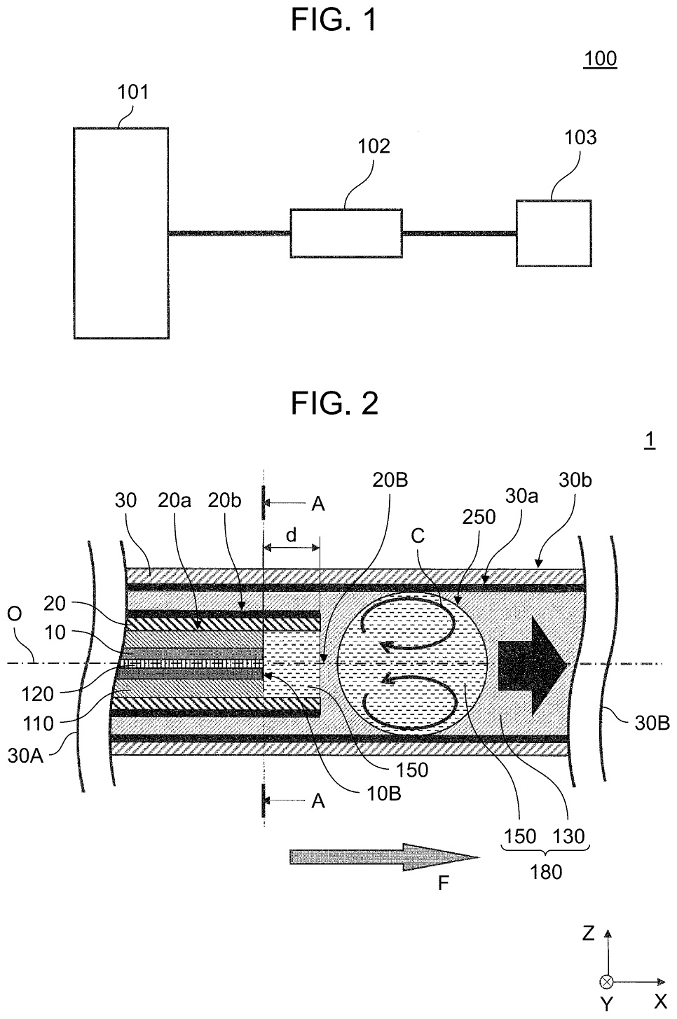

FIG. 1 is a schematic cross-sectional view illustrating a configuration of microflow synthesis apparatus 100 according to a first exemplary embodiment. Microflow synthesis apparatus 100 shown in FIG. 1 is used to produce a product by introducing two or more fluids, mixing them, and reacting them.

As illustrated in FIG. 1, microflow synthesis apparatus 100 includes raw material supply unit 101, reaction unit 102, and collection unit 103. Raw material supply unit 101 is configured to feed two or more fluids and supply the two or more fluids to reaction unit 102. Raw material supply unit 101 can include, for example, a liquid feeding device (not illustrated) such as a syringe pump, a plunger pump, a diaphragm pump, a tube pump, a progressive cavity pump, or a piezo pump. Further, a flow rate adjusting device (not illustrated) such as a flow meter and a proportional control supply valve can be provided in raw material supply unit 101.

Reaction unit 102 includes a flow reactor to be described later, mixes two or more fluids supplied by raw material supply unit 101, and appropriately maintains them in a constant temperature state for reaction. Fluid supplied by raw material supply unit 101 may be liquid or gas. Further, two or more fluids only need to have affinity with each other, and may be either water-soluble or water-insoluble. For example, the two or more fluids may be aqueous liquids or may be organic solvents or oily liquids. Further, the two or more fluids can also be introduced into reaction unit 102 to have any mixing ratio.

Collection unit 103 collects a product produced by a desired reaction in reaction unit 102.

### <Configuration of Flow Reactor>

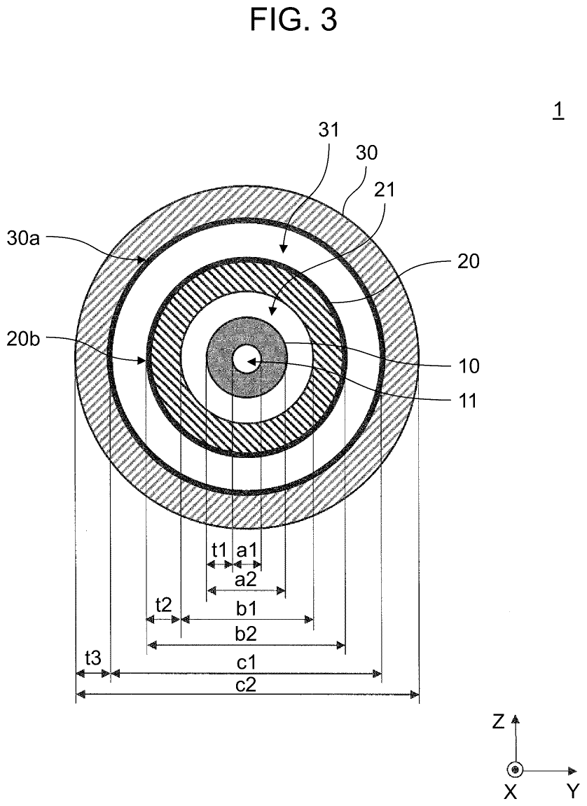

A configuration of flow reactor 1 included in reaction unit 102 of FIG. 1 will be described with reference to FIGS. 2 and 3. FIG. 2 is a schematic cross-sectional view illustrating a configuration of flow reactor 1 according to the first exemplary embodiment. FIG. 3 is a schematic cross-sectional view of an A-A plane of flow reactor 1 of FIG. 2. Note that, in FIG. 2, a +X direction is defined as fluid flow direction F, and a configuration of flow reactor 1 and fluid in flow reactor 1 are shown in an X-Z plane. FIG. 3 does not show fluid in flow reactor 1, but shows only a configuration of flow reactor 1 on a Y-Z plane for easy viewing.

Flow reactor 1 according to the first exemplary embodiment of the present disclosure includes inner tubular portion 10 on the inner side, inner tubular portion 20 on the outer side, and outer tubular portion 30 arranged in parallel in an X direction in the drawing. As shown in FIG. 2, inner tubular portion 20 on the outer side is disposed in a part of the inside of outer tubular portion 30, and fluidly communicates with outer tubular portion 30 at tip 20B of inner tubular portion 20 on the outer side. Inner tubular portion 10 on the inner side is disposed in a part of the inside of inner tubular portion 20 on the outer side and fluidly communicates with inner tubular portion 20 on the outer side at tip 10B of inner tubular portion 10 on the inner side. As illustrated in FIG. 3, on the A-A plane viewed from the X direction in the drawing, flow reactor 1 has a triple tube structure. Note that, in the present description, the “inner tubular portion on the outer side” may be referred to as a “first inner tubular portion”, the “inner tubular portion on the inner side” may be referred to as a “second inner tubular portion”, the “tip 20B” may be referred to as a “first tip”, and the “tip 10B” may be referred to as a “second tip”.

As illustrated in the drawing, outer tubular portion 30 in which inner tubular portion 10 on the inner side and inner tubular portion 20 on the outer side are disposed in a part of the inside is used to transport a plurality of fluids, and a plurality of fluids can flow in the inside from upstream end 30A to downstream end 30B of outer tubular portion 30 in flow direction F. Hereinafter, flows of a plurality of fluids flowing in outer tubular portion 30 will be described with reference to FIG. 2.

As illustrated in FIG. 2, first fluid 110 is introduced between an outer wall of inner tubular portion 10 on the inner side and an inner wall of inner tubular portion 20 on the outer side so as to flow toward tip 20B of inner tubular portion 20 on the outer side in flow direction F. Second fluid 120 is introduced so as to flow toward tip 10B in flow direction F inside inner tubular portion 10 on the inner side. First fluid 110 and second fluid 120 come into contact with each other near tip 10B of inner tubular portion 10 on the inner side to generate mixed fluid 150. Mixed fluid 150 flows into outer tubular portion 30 at tip 20B of inner tubular portion 20 on the outer side.

Mixed fluid 150 flowing into outer tubular portion 30 from tip 20B of inner tubular portion 20 on the outer side further comes into contact with third fluid 130. Third fluid 130 is introduced between an outer wall of inner tubular portion 20 on the outer side and an inner wall of outer tubular portion 30 so as to flow toward downstream end 30B in flow direction F, merges with mixed fluid 150 at tip 20B, and further flows toward downstream end 30B.

In the present exemplary embodiment, third fluid 130 is a fluid having low affinity for first fluid 110 and second fluid 120. As used in the present description, low affinity means low solubility, and is not limited to being completely insoluble in each other. That “third fluid 130 has low affinity for first fluid 110 and second fluid 120” means that affinity between third fluid 130 and first fluid 110 and second fluid 120 is lower than affinity between first fluid 110 and second fluid 120.

When fluids of low affinity flow simultaneously in a flow path, the fluids are separated from one another by a phase interface, and a “segment flow” (also referred to as a “slag flow”) including a fluid segment is formed. In the present exemplary embodiment, as shown in FIG. 2, when mixed fluid 150 merges with third fluid 130 having low affinity for first fluid 110 and second fluid 120 constituting mixed fluid 150 at tip 20B, mixed fluid 150 is divided into individual segments 250, and segment flow 180 including segment 250 and third fluid 130 is formed. In segment flow 180, the individual segment 250 and third fluid 130 are transported to the downstream side so as to be alternately aligned and translated inside outer tubular portion 30. In the present exemplary embodiment, by forming segment flow 180, it is possible to suppress adhesion of a product to a flow path in the flow reactor. This will be described in detail later.

A triple tube structure of flow reactor 1 will be described in more detail with reference to FIG. 3.

### (Inner Tubular Portion 10 on the Inner Side)

Inner tubular portion 10 on the inner side has hollow portion 11 (shown in FIG. 3) capable of transporting second fluid 120 in the inside, and is configured such that a part can be disposed inside inner tubular portion 20 on the outer side. As inner tubular portion 10 on the inner side, for example, one formed from stainless steel such as SUS304, SUS316, or SUS316L, a metal material such as Hastelloy, or a resin material such as PP, PFA, PTFE, PEEK, or PPS, or its tube can be used. In FIG. 3, hollow portion 11 is shown to have a circular cross section in a plane perpendicular to axis O of inner tubular portion 10 on the inner side extending in the X direction, but the present disclosure is not limited to the shape of the cross section of hollow portion 11. The cross section of hollow portion 11 may have, for example, an elliptical shape, a polygonal shape, or the like.

An inner diameter a1 of inner tubular portion 10 on the inner side is desirably 0.15 mm or more for convenience of production and for ensuring a flow rate of fluid to be transported. Further, in order to ensure sufficient strength, thickness t1 of a peripheral wall of inner tubular portion 10 on the inner side is desirably 0.05 mm or more. An outer diameter of a portion of inner tubular portion 10 on the inner side disposed inside inner tubular portion 20 on the outer side, for example, outer diameter a2 on the A-A plane illustrated in FIG. 3 can be set so as to allow arrangement inside hollow portion 21 of inner tubular portion 20 on the outer side.

### (Inner Tubular Portion 20 on the Outer Side)

inner tubular portion 20 on the outer side has hollow portion 21 (shown in FIG. 3) capable of transporting first fluid 110 in the inside, and is configured such that a part of inner tubular portion 10 on the inner side can be disposed inside hollow portion 21, and a part of inner tubular portion 20 on the outer side can be disposed inside outer tubular portion 30.

As inner tubular portion 20 on the outer side, for example, one formed from stainless steel such as SUS304, SUS316, or SUS316L, a metal material such as Hastelloy, or a resin material such as PP, PFA, PTFE, PEEK, or PPS, or its tube can be used. In FIG. 3, hollow portion 21 is shown to have a circular cross section in a plane perpendicular to axis O of inner tubular portion 20 on the outer side extending in the X direction, but the present disclosure is not limited to the shape of the cross section of hollow portion 21. The cross section of hollow portion 21 may have, for example, an elliptical shape, a polygonal shape, or the like.

Preferably, inner diameter b1 of inner tubular portion 20 on the outer side is 0.5 mm or more and less than 30 mm. More preferably, inner diameter b1 of inner tubular portion 20 on the outer side ranges from 0.5 mm to 20 mm inclusive. When inner diameter b1 is too small, for example, when inner diameter b1 is less than 0.5 mm, a member configuration for disposing a part of inner tubular portion 10 on the inner side inside inner tubular portion 20 on the outer side becomes difficult, which is not preferable. Further, when mixed fluid 150 is introduced from tip 20B of inner tubular portion 20 on the outer side to outer tubular portion 30, it is necessary to maintain segment 250 by surface tension of mixed fluid 150 in order to form stable segment flow 180. When inner diameter b1 of inner tubular portion 20 on the outer side is too large, for example, 30 mm or more, it is difficult to maintain segment 250 by surface tension of mixed fluid 150, and after merging, mixed fluid 150 and third fluid 130 become a separated fluid flow parallel to flow direction F due to a difference in specific gravity between them, and a segment flow cannot be formed, which is not desirable.

Thickness t2 of a peripheral wall of inner tubular portion 20 on the outer side may be the same as or different from thickness t1 of a peripheral wall of inner tubular portion 10 on the inner side. In order to ensure sufficient strength, thickness t2 is desirably 0.05 mm or more. An outer diameter of a portion of inner tubular portion 20 on the outer side disposed inside outer tubular portion 30, for example, outer diameter b2 on the A-A plane illustrated in FIG. 3 can be set so as to allow arrangement inside hollow portion 31 of outer tubular portion 30.

### (Outer Tubular Portion 30)

Outer tubular portion 30 has hollow portion 31 (shown in FIG. 3) capable of transporting third fluid 130 in the inside, and is configured such that a part of inner tubular portion 20 on the outer side can be disposed inside hollow portion 31. As outer tubular portion 30, for example, one formed from stainless steel such as SUS316 or SUS316L, a metal material such as Hastelloy, or a resin material such as PP, PFA, PTFE, PEEK, or PPS, or its tube can be used. In FIG. 3, hollow portion 31 is shown to have a circular cross section in a plane perpendicular to axis O of outer tubular portion 30 extending in the X direction, but the present disclosure is not limited to the shape of the cross section of hollow portion 31. The cross section of hollow portion 31 may have, for example, an elliptical shape, a polygonal shape, or the like.

Inner diameter c1 of outer tubular portion 30 can be designed to facilitate arrangement of a portion of inner tubular portion 20 on the outer side, and preferably inner diameter c1 of outer tubular portion 30 is less than 35 mm. When inner diameter c1 of outer tubular portion 30 is too large, for example, 35 mm or more, it is difficult to maintain segment 250 by surface tension of mixed fluid 150, and after merging, mixed fluid 150 and third fluid 130 become a separated fluid flow parallel to flow direction F due to a difference in specific gravity between them, and a segment flow cannot be formed, which is not desirable.

Thickness t3 of a peripheral wall of outer tubular portion 30 may be the same as or different from thickness t2 of a peripheral wall of inner tubular portion 20 on the outer side or thickness t1 of a peripheral wall of inner tubular portion 10 on the inner side. In order to ensure sufficient strength, thickness t3 is desirably 0.05 mm or more. An outer diameter c2 of outer tubular portion 30 on the A-A plane illustrated in FIG. 3 can be appropriately set according to use and convenience of production, and the present disclosure is not limited to this.

Note that although FIGS. 2 and 3 illustrate flow reactor 1 having a coaxial triple tube structure including inner tubular portion 10 on the inner side, inner tubular portion 20 on the outer side, and outer tubular portion 30 having the identical axis O, the present disclosure is not limited to flow reactor 1 having a coaxial triple tube structure. Preferably, inner tubular portion 10 on the inner side, inner tubular portion 20 on the outer side, and outer tubular portion 30 are disposed to have substantially the same axial direction. By this, flow reactor 1 can be assembled more easily. Further, preferably, inner tubular portion 10 on the inner side, inner tubular portion 20 on the outer side, and outer tubular portion 30 are disposed such that adjacent wall surfaces do not come into contact with each other. By this, more stable segment flow 180 can be formed in flow reactor 1. Further, the present disclosure is not limited to the hollow portions 11,21, and 31 having the same shape. When hollow portions 11,21, and 31 have the same shape, it is possible to suppress occurrence of flow turbulence at a contact interface between fluid 110 and fluid 120 and a contact interface between mixed fluid 150 and fluid 130, which may be advantageous for formation of stable segment flow 180. Further, the present disclosure is not limited to the shape of tip 10B of inner tubular portion 10 on the inner side or the shape of tip 20B of inner tubular portion 20 on the outer side. For example, at least one of tip 10B and tip 20B may have a tapered shape toward the downstream side.

### (Arrangement of Tip)

In the present exemplary embodiment, as illustrated in FIG. 2, tip 20B of inner tubular portion 20 on the outer side is located upstream of downstream end 30B of outer tubular portion 30 when viewed from the Y direction in the drawing. Tip 10B of inner tubular portion 10 on the inner side is disposed so as not to protrude downstream from tip 20B of inner tubular portion 20 on the outer side. By this, first fluid 110 and second fluid 120 form mixed fluid 150 before reaching tip 20B, formed mixed fluid 150 can merge with third fluid 130 at tip 20B to form stable segment flow 180, and formed segment flow 180 can be transported further to the downstream side in outer tubular portion 30.

Further, in the present exemplary embodiment, as illustrated in FIG. 2, when viewed from the Y direction in the drawing, a gap can be provided between tip 10B of inner tubular portion 10 on the inner side and tip 20B of inner tubular portion 20 on the outer side. The gap may have length d along flow direction F, preferably length d satisfies 0 mm≤d<50 mm. More preferably, length d satisfies 0 mm≤d≤20 mm.

When length d of the gap is too long, for example, 50 mm or more, a synthesis reaction between first fluid 110 and second fluid 120 proceeds in mixed fluid 150, and product adhesion and deposition may occur in hollow portion 21 of the inner tubular portion 20 on the outer side. By this, hollow portion 21 of inner tubular portion 20 on the outer side may be blocked, which is not desirable. Further, even if hollow portion 21 of inner tubular portion 20 on the outer side is not blocked, a product may adhere to tip 10B of inner tubular portion 10 on the inner side by disturbance of a flow of mixed fluid 150, and hollow portion 11 of inner tubular portion 10 on the inner side may be blocked, and therefore, a gap having a length of 50 mm or more is not desirable. Furthermore, also from the viewpoint of mixing performance of flow reactor 1, it is preferable to form segment flow 180 quickly after forming mixed fluid 150, and in a case of having a gap having a length of 50 mm or more, it is not preferable since it takes time from formation of mixed fluid 150 to formation of segment flow 180 in hollow portion 31 of outer tubular portion 30.

On the other hand, when tip 10B of inner tubular portion 10 on the inner side protrudes to the downstream side from tip 20B of inner tubular portion 20 on the outer side, first fluid 110 and second fluid 120 separately come into contact with third fluid 130 before formation of mixed fluid 150 by first fluid 110 and second fluid 120, which is undesirable because it is difficult to form a stable segment flow.

### (Liquid Repellency of Wall Surface)

In the present exemplary embodiment, outer wall surface 20b of inner tubular portion 20 on the outer side can be formed to have liquid repellency (hydrophobicity). Liquid repellency generally refers to property that a contact angle with liquid is larger than a predetermined angle, and in a case where liquid is water, liquid repellency is also referred to as water repellency (hydrophobicity). In the present description, liquid repellency of outer wall surface 20b means that wettability of mixed fluid 150 with respect to outer wall surface 20b of inner tubular portion 20 on the outer side is lower than wettability of third fluid 130 with respect to outer wall surface 20b of inner tubular portion 20 on the outer side.

Liquid repellency of outer wall surface 20b may be achieved by property of a material of inner tubular portion 20 on the outer side itself, or may be achieved by using a means such as fluororesin coating or plating. By imparting liquid repellency to outer wall surface 20b, it is possible to cause liquid breakage in the vicinity of outer wall surface 20b of inner tubular portion 20 on the outer side when mixed fluid 150 is divided into segments 250. By this, when a segment flow is formed using gas such as nitrogen gas or liquid having viscosity significantly different from that of mixed fluid 150 as third fluid 130, third fluid 130 is less likely to flow into hollow portion 21 of inner tubular portion 20 on the outer side, and it is possible to prevent adhesion and deposition of a product to hollow portion 11 of inner tubular portion 10 on the inner side, which may be caused by turbulence of a flow of mixed fluid 150.

Furthermore, in the present exemplary embodiment, inner wall surface 30a of outer tubular portion 30 can be formed to have liquid repellency. In the present description, liquid repellency of inner wall surface 30a means that wettability of mixed fluid 150 to inner wall surface 30a of outer tubular portion 30 is lower than the wettability of third fluid 130 to inner wall surface 30a of outer tubular portion 30.

Liquid repellency of inner wall surface 30a of outer tubular portion 30 may be achieved by property of a material of inner tubular portion 20 on the outer side itself, or may be achieved by using a means such as fluororesin coating or plating. By imparting liquid repellency to inner wall surface 30a, a more stable segment flow can be formed in hollow portion 31 of outer tubular portion 30.

Note that first fluid 110, second fluid 120, and third fluid 130 may be introduced into flow reactor 1 from an upstream end portion (not shown) of each of inner tubular portion 10 on the inner side, inner tubular portion 20 on the outer side, and outer tubular portion 30, or from a wall surface of each of them. The present disclosure is not limited to this. Further, a pipe for transporting fluid and a connection portion or a joint for connecting these pipes can be used at least between a raw material supply unit on the upstream side and flow reactor 1 and between flow reactor 1 and collection unit 103 on the downstream side. A conventionally known configuration can be employed for introduction of fluid from the upstream side of flow reactor 1 and transportation of fluid to the downstream side, and further detailed description is omitted in the present description.

### (Mechanism of Suppressing Adhesion of Product by Segment Flow)

According to flow reactor 1 of the present exemplary embodiment, mixed fluid 150 is formed, and then merges with third fluid 130 to form segment flow 180, so that adhesion of a product in flow reactor 1 to a flow path can be suppressed. It is considered that an effect of suppressing adhesion of a product by a segment flow is due to an effect of a flow field of the segment flow and surface tension.

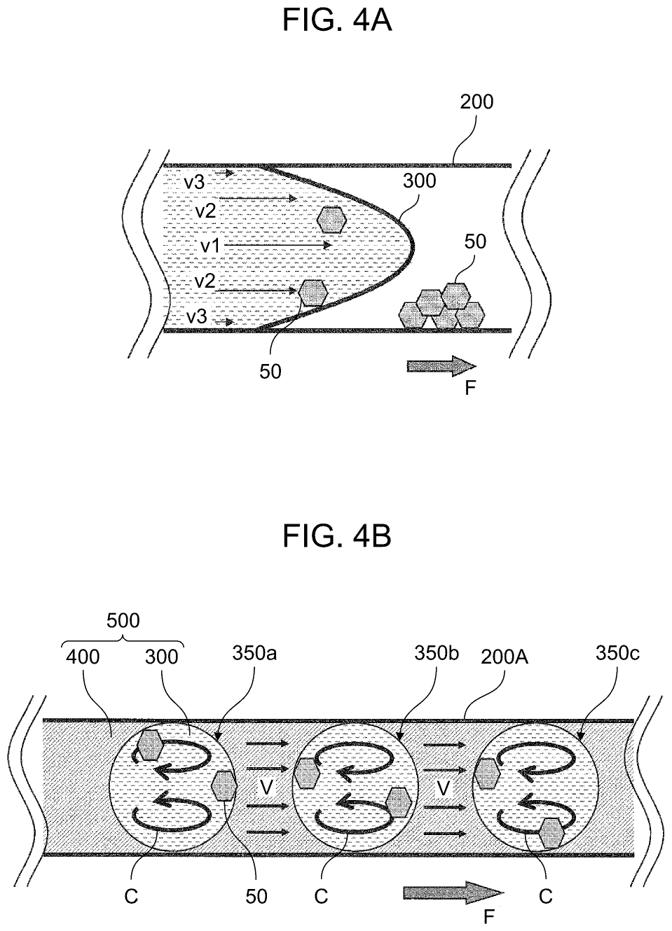

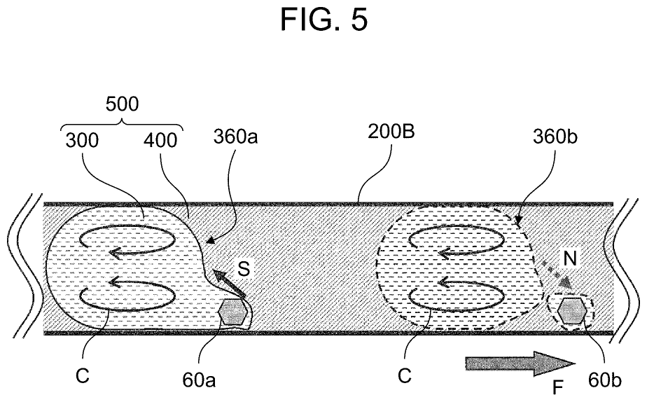

Next, with reference to FIGS. 4A to 5, a mechanism for suppressing adhesion of a product in a flow reactor to a flow path by forming a segment flow will be described. FIG. 4A is a diagram for explaining an effect of a flow field of a segment flow in the flow reactor of the present disclosure, and is a conceptual diagram illustrating a flow field in which no segment flow is formed, and FIG. 4B is a diagram for explaining an effect of a flow field of a segment flow in the flow reactor of the present disclosure, and is a conceptual diagram illustrating a flow field in which a segment flow is formed. FIG. 5 is a conceptual diagram for explaining an effect of surface tension of a segment flow in the flow reactor of the present disclosure.

### (Flow Field of Segment Flow)

As shown in FIG. 4A, in a flow field in which no segment flow is formed, spatial distribution of flow velocity occurs in flow path 200 in which mixed fluid 300 containing a first fluid and a second fluid (not shown) flows. Flow velocity v1 near the center of flow path 200 is the maximum, the flow velocity decreases toward an inner wall of flow path 200, and flow velocity v3 becomes a value close to 0 near the inner wall. By this, particles and polymer 50 synthesized by the first fluid and the second fluid are easily attached to an inner wall of flow path 200, and deposition of attached product particles causes flow path 200 to be blocked.

On the other hand, in flow path 200A shown in FIG. 4B, mixed fluid 300 merges with third fluid 400 having low affinity for the first fluid and the second fluid (not shown) contained in mixed fluid 300 to form segment flow 500. In segment flow 500, segments 350a, 350b, and 350c and third fluid 400 can flow alternately side by side at average transport velocity V in flow path 200A. It is known that convection C occurs in each of segments 350a, 350b, and 350c. Convection C generates a flow velocity equivalent to average transport velocity V of segment flow 500 in segments 350a, 350b, and 350c. By this, fluid has a sufficient flow rate also in the vicinity of an inner wall of flow path 200A, and adhesion of particles of a product and polymer 50 contained in segments 350a, 350b, and 350c to an inner wall of flow path 200A is suppressed, and a flow path can be prevented from being blocked by deposition of the particles of the product. In this way, when a segment flow is formed, adhesion of a product to a wall surface of a flow path can be suppressed by a flow field of a segment flow.

### (Effect of Surface Tension of Segment Flow)

An effect of surface tension of a segment flow will be described with reference to FIG. 5. In flow path 200B shown in FIG. 5, segment flow 500 is formed by mixed fluid 300 and third fluid 400 having low affinity for the first fluid and the second fluid (not shown) contained in mixed fluid 300. In segment 360a of segment flow 500, synthesized particles and polymer 60a synthesized by the first fluid and the second fluid are in a state of being wetted (well-wetted) with mixed fluid 300, and at this time, surface tension S acting to reduce a surface area of segment 360a tends to draw the particles and polymer 60a into segment 360a.

The fact that particles and polymer 60a in segment 360a adhere to the inner wall of flow path 200B means that the particles and polymer 60b are separated from segment 360b as in segment 360b schematically shown in FIG. 5. In order for separation from segment 360b, mixed fluid 300 forming segment 360b needs to be divided into droplets or single particles. For this purpose, shear force N against surface tension S for drawing particles or polymer 60a into segment 360a is required. A flow field forming a segment flow in a flow path is a laminar flow, and shear force N against surface tension S is hardly generated in a flow path, and therefore, adhesion of particles of a product and polymer 60a contained in segment 360a to an inner wall of flow path 200B is suppressed, and the flow path can be prevented from being blocked by deposition of the particles of the product. In this way, when a segment flow is formed, adhesion of a product to a wall surface of a flow path can be further suppressed by an effect of surface tension of the segment flow.

Further, formation of a segment flow can not only suppress adhesion of a product to a wall surface of a flow path, but also can quickly and uniformly mix first fluid 110 and second fluid 120 in segment 250 by convection C generated in segment 250 as illustrated in FIG. 2, and can promote synthesis reaction.

Furthermore, referring to FIG. 2, according to flow reactor 1 of the present exemplary embodiment, mixed fluid 150 can be divided into segments 250 such that the third fluid merges with mixed fluid 150 from all directions on a Y-Z plane perpendicular to flow direction F in the X direction, and mixed fluid 150 is throttled from all directions. For this reason, a mixing ratio of first fluid 110 and second fluid 120 for each segment 250 is kept constant, and quality of particles and polymers to be synthesized can be kept constant. On the other hand, for example, when a segment flow is formed using a general-purpose T-shaped or Y-shaped mixer, the third fluid merges with mixed fluid only from a predetermined direction, so that the mixed fluid is asymmetrically divided into segments. In this case, a mixing ratio of the first fluid and the second fluid varies for each divided segment, and quality of particles and polymers to be synthesized may also vary.

According to flow reactor 1 of the best mode according to an exemplary embodiment of the present disclosure, after the first fluid and the second fluid form mixed fluid, the first fluid and the second fluid merge with the third fluid to form a segment flow to be transported. This makes it possible to suppress adhesion of a product to a flow path and to prevent blockage of a flow path due to deposition of particles of the product.

### Application Example

A microflow synthesis apparatus including experimentally produced flow reactor 1 according to the present exemplary embodiment was applied to production of lithium aluminum fluoride fine particles. Hereinafter, verification of an effect of suppressing adhesion of a product to a flow path by the flow reactor of the present disclosure will be described in detail in Application Example 1-9.

### <Method of Producing Lithium Aluminum Fluoride Fine Particles>

Ammonium fluoride was dissolved in pure water to prepare aqueous solution A having a concentration of 750 mM. Lithium nitrate and aluminum nitrate were dissolved in pure water and mixed to prepare mixed fluids B having concentrations of lithium nitrate and aluminum nitrate at 375 mM and 125 mM. As a first fluid, aqueous solution A was introduced into inner tubular portion 20 on the outer side of flow reactor 1 shown in FIG. 2, for example, so that a flow rate was 5 mL/min by using a plunger pump manufactured by Flom corporation. As a second fluid, mixed fluid B was introduced into inner tubular portion 10 on the inner side of flow reactor 1 shown in FIG. 2, for example, so that a flow rate was 5 mL/min by using a plunger pump manufactured by Flom corporation. Note that although it has been described in Application Example 1-9 that aqueous solution A is the first fluid and mixed fluid B is the second fluid, the present disclosure is not limited to this. For example, mixed fluid B can be introduced into inner tubular portion 20 on the outer side as the first fluid, and aqueous solution A can be introduced into inner tubular portion 10 on the inner side as the second fluid.

In order to form a segment flow, N₂ gas as the third fluid was introduced into outer tubular portion 30 of flow reactor 1 shown in FIG. 2 at a flow rate of 10 ml/min by using a mass flow controller manufactured by DFC corporation.

In flow reactor 1, crystallization reaction proceeds by mixing of aqueous solution A as the first fluid and mixed fluid B as the second fluid in the vicinity of tip 10B of inner tubular portion 10, and the generated aqueous solution containing lithium aluminum fluoride fine particles merges with the N₂ gas of the third fluid in the vicinity of tip 20B of inner tubular portion 20 on the outer side and flows further to the downstream side. After the production was performed for one hour, the lithium aluminum fluoride fine particle-containing solution produced downstream of flow reactor 1 was collected.

### Application Example 1

### <Production of Flow Reactor>

Each of inner tubular portion 10 on the inner side, inner tubular portion 20 on the outer side, and outer tubular portion 30 of flow reactor 1 in FIG. 2 was produced by processing a cylinder made from SUS316. Referring to FIG. 3, manufactured inner tubular portion 10 had inner diameter a1 of 1 mm and a part near tip 10B had outer diameter a2 of 1.25 mm so as to be able to be inserted into a part of inner tubular portion 20 on the outer side. Produced inner tubular portion 20 on the outer side had inner diameter b1 of 1.5 mm, and a part near tip 20B had an outer diameter b2 of 1.75 mm so as to be able to be inserted into a part of outer tubular portion 30. Produced outer tubular portion 30 had inner diameter c1 of 2 mm and outer diameter c2 of 50 mm.

Referring to FIG. 2, in assembled flow reactor 1, length d of a gap between tip 10B of inner tubular portion 10 on the inner side and tip 20B of inner tubular portion 20 on the outer side was 1 mm, and length between tip 20B of inner tubular portion 20 on the outer side and downstream end 30B of outer tubular portion 30 was 10 mm.

Further, the mixed fluid B of the second fluid was introduced from an end portion on the upstream side of inner tubular portion 10 on the inner side. Through holes were provided from outer wall surfaces 20b and 30b to inner wall surfaces 20a and 30a at predetermined positions of outer tubular portion 30 and inner tubular portion 20 on the outer side on the upstream side of tip 10B of inner tubular portion 10 on the inner side, and aqueous solution A of the first fluid and N₂ gas of the third fluid were introduced. Further, as a pipe for introducing or transporting fluid, a PFA tube having an inner diameter of 2.18 mm was used. On the downstream side of flow reactor 1, a PFA tube having an inner diameter of 2.18 mm and a length of about 2 m was connected to downstream end 30B of outer tubular portion 30, and the produced lithium aluminum fluoride fine particle-containing solution was collected.

In Application Example 2-9, flow reactor 1 was produced with different parameters as follows with respect to Application Example 1 described above.

### Application Example 2-3

In Application Example 2-3, an inner diameter and an outer diameter of inner tubular portion 10 on the inner side, inner tubular portion 20 on the outer side, and outer tubular portion 30 were set to be similar to those in Application Example 1, and length d of a gap between tip 10B of inner tubular portion 10 on the inner side and tip 20B of inner tubular portion 20 on the outer side was changed with respect to Application Example 1 to produce flow reactor 1.

### Application Example 4-7

Further, in Application Example 4-7, flow reactor 1 was fabricated by changing inner diameter b1 and outer diameter b2 of inner tubular portion 20 on the outer side with respect to Application Example 1.

In Application Example 4, inner tubular portion 20 on the outer side was manufactured so that inner diameter b1 was 0.5 mm and outer diameter b2 was 1 mm. At this time, inner tubular portion 10 on the inner side had inner diameter a1 of 0.15 mm and outer diameter a2 of 0.35 mm. Outer tubular portion 30 was similar to that in Application Example 1. In Application Example 5, inner tubular portion 20 on the outer side was manufactured so that inner diameter b1 was 20 mm and outer diameter b2 was 22 mm. At this time, inner tubular portion 10 on the inner side had inner diameter a1 of 10 mm and outer diameter a2 of 12 mm. Outer tubular portion 30 had inner diameter c1 of 25 mm and outer diameter c2 of 50 mm.

In Application Example 6, inner tubular portion 20 on the outer side was manufactured so that inner diameter b1 was 0.4 mm. Other dimensions were the same as those in Application Example 4. In Application Example 7, inner tubular portion 20 on the outer side was manufactured so that inner diameter b1 was 30 mm and outer diameter b2 was 32 mm. At this time, inner tubular portion 10 on the inner side had inner diameter a1 of 0.15 mm and outer diameter a2 of 0.35 mm. Outer tubular portion 30 had inner diameter c1 of 35 mm and outer diameter c2 of 50 mm.

### Application Example 8-9

Furthermore, in Application Example 8-9, flow reactor 1 was produced with the same dimensional parameters as in Application Example 1, and, furthermore, with respect to Application Example 1, liquid repellency was imparted to an outer wall surface of inner tubular portion 20 on the outer side (Application Example 8) or an inner wall surface of outer tubular portion 30 (Application Example 9) of produced flow reactor 1.

In Application Example 1-9, lithium aluminum fluoride fine particles were produced using each of flow reactors 1 produced with the different parameters described above. In production of lithium aluminum fluoride fine particles, mixing performance (hereinafter, referred to as “fluid mixing performance”) of aqueous solution A as the first fluid and mixed fluid B as the second fluid by flow reactor 1 and performance (hereinafter, referred to as “adhesion suppression performance”) of suppressing adhesion of a product to a flow path differ depending on the parameters of flow reactor 1 used, and quality of the produced lithium aluminum fluoride fine particles is affected by them. In the production of lithium aluminum fluoride fine particles performed in Application Example 1-9, “fluid mixing performance” and “adhesion suppression performance” by flow reactor 1 produced with different parameters were evaluated.

### <Method of Evaluating “Fluid Mixing Performance” and “Adhesion Suppression Performance”>

In order to evaluate the “fluid mixing performance”, a particle diameter of produced lithium aluminum fluoride fine particles was measured using a particle diameter measurement system manufactured by OTSUKA ELECTRONICS CO., LTD. In general, when mixing performance is low, a particle diameter is large. Without limitation to the above, in the production of lithium aluminum fluoride fine particles performed in Application Example 1-9, when an average particle diameter of produced lithium aluminum fluoride fine particles was larger than 1 μm, it was evaluated that “mixing performance is low”, and when the average particle diameter was 1 μm or less, it was evaluated that “mixing performance is high”. The “fluid mixing performance” can be evaluated based on different criteria depending on a type of fine particles to be produced. In order to evaluate the “adhesion suppression performance”, a sensor part of a pressure sensor unit manufactured by DFC corporation was connected to a liquid feed port of a plunger pump that transports the first fluid, and a pressure profile inside a flow path on the upstream side of flow reactor 1 was measured. When increase in pressure is observed, it can be determined that flow path blockage occurs due to adhesion or deposition of a product on an inner wall surface of a flow path, and when increase in pressure is not observed, it can be determined that flow path blockage does not occur. Without limitation to the above, in the production of lithium aluminum fluoride fine particles of Application Example 1-9, when a maximum pressure increase value was 50 kPa or more with respect to pressure inside a flow path at the start of synthesis, it was evaluated that the “adhesion suppression performance is low”. Further, when a maximum pressure increase value was 10 kPa or more and less than 50 kPa with respect to pressure inside a flow path at the start of synthesis, it was evaluated that “adhesion suppression performance is exhibited”. Furthermore, when a maximum pressure increase value was less than 10 kPa with respect to pressure inside a flow path at the start of synthesis, it was evaluated that “excellent adhesion suppression performance is exhibited”. Note that the “adhesion suppression performance” can be evaluated based on different criteria depending on a type of fine particles to be produced.

In Application Example 1-9, Table 1 shows a parameter of each of produced flow reactors 1, a measurement result of a maximum pressure increase value in a flow path on the upstream side of flow reactor 1 and an average particle diameter of produced lithium aluminum fluoride fine particles, and evaluation results of the “fluid mixing performance” and the “adhesion suppression performance” for flow reactor 1 used in each application example. Table 1 shows, among parameters of flow reactor 1, a value of “inner diameter b1” that is an inner diameter of inner tubular portion 20 on the outer side, a value of “length d” that is a length of a gap between tip 10B of inner tubular portion 10 on the inner side and tip 20B of inner tubular portion 20 on the outer side, presence or absence of “liquid repellency 1” that is liquid repellency of outer wall surface 20b of inner tubular portion 20 on the outer side, and presence or absence of “liquid repellency 2” that is liquid repellency of inner wall surface 30a of outer tubular portion 30. Further, in Table 1, an evaluation that “mixing performance is high” is indicated by O, and an evaluation that “mixing performance is low” is indicated by X. An evaluation that “excellent adhesion suppression performance is exhibited” is indicated by O, an evaluation that “adhesion suppression performance is exhibited” is indicated by O, and an evaluation that “adhesion suppression performance is low” is indicated by X.

TABLE 1

| | | | | | | Maximum | | |
|---|---|---|---|---|---|---|---|---|
| | Inner | | | | Average | pressure | | |
| | diameter | Length | Liquid | Liquid | particle | increase | Fluid | Adhesion |
| | b1 | d | repellency | repellency | diameter | value | mixing | suppression |
| | (mm) | (mm) | 1 | 2 | (μm) | (kPa) | performance | performance |
| Application | 1.5 | 1 | Absent | Absent | 0.63 | 11 | ◯ | ◯ |
| Example 1 | | | | | | | | |
| Application | 1.5 | 10 | Absent | Absent | 0.69 | 17 | ◯ | ◯ |
| Example 2 | | | | | | | | |
| Application | 1.5 | 50 | Absent | Absent | 1.1 | 491 | X | X |
| Example 3 | | | | | | | | |
| Application | 0.5 | 1 | Absent | Absent | 0.51 | 48 | ◯ | ◯ |
| Example 4 | | | | | | | | |
| Application | 20 | 20 | Absent | Absent | 0.9 | 2 | ◯ | ⊙ |
| Example 5 | | | | | | | | |
| Application | 0.4 | 1 | Absent | Absent | — | — | — | — |
| Example 6 | | | | | | | | |
| Application | 30 | 30 | Absent | Absent | 2.4 | 2 | X | ⊙ |
| Example 7 | | | | | | | | |
| Application | 1.5 | 1 | Present | Absent | 0.66 | 8 | ◯ | ⊙ |
| Example 8 | | | | | | | | |
| Application | 1.5 | 1 | Absent | Present | 0.65 | 7 | ◯ | ⊙ |
| Example 9 | | | | | | | | |

### <Evaluation of Application Example>

Regarding Application Example 1-3, when inner diameter b1 of inner tubular portion 20 on the outer side was 1.5 mm, Application Example 1 in which length d of the gap was 1 mm and Application Example 2 in which length d of the gap was 10 mm showed that mixing performance was high and adhesion suppression performance was exhibited. On the other hand, in Application Example 3 in which length d of the gap was 50 mm, produced lithium aluminum fluoride fine particles had an average particle diameter of more than 1 μm, and it was evaluated that “mixing performance is low”. Further, since the maximum pressure increase value exceeded 50 kPa, it was evaluated that “adhesion suppression performance is low”.

From results of Application Example 1-3, it has been found that length d of the gap of the flow reactor is desirably less than 50 mm in order to achieve sufficient mixing performance and adhesion suppression performance when the flow reactor of the present exemplary embodiment is applied to production of lithium aluminum fluoride fine particles.

Regarding Application Example 4-7, both of Application Example 4 in which inner diameter b1 of inner tubular portion 20 on the outer side was 0.5 mm and length d of the gap was 1 mm and Application Example 5 in which inner diameter b1 of inner tubular portion 20 on the outer side was 20 mm and length d of the gap was 20 mm had high mixing performance, and evaluation that “adhesion suppression performance is exhibited” or “excellent adhesion suppression performance is exhibited” was obtained. On the other hand, in Application Example 6 in which inner diameter b1 of inner tubular portion 20 on the outer side was 0.4 mm and length d of the gap was 1 mm, it was difficult to dispose inner tubular portion 10 on the inner side inside inner tubular portion 20 on the outer side, it was difficult to produce flow reactor 1 maintaining quality, and the mixing performance and the adhesion suppression performance were unevaluable. Further, for Application Example 7 in which inner diameter b1 of inner tubular portion 20 on the outer side was 30 mm and length d of the gap was 30 mm, evaluation that mixing performance is low but “excellent adhesion suppression performance is exhibited” was obtained.

From results of Application Example 4-7, it has been found that inner diameter b1 of the inner tubular portion on the outer side of the flow reactor desirably ranges from 0.5 mm to 20 mm inclusive in order to achieve sufficient mixing performance and adhesion suppression performance when the flow reactor of the present exemplary embodiment is applied to production of lithium aluminum fluoride fine particles.

In the case of Application Example 8-9 having dimensional parameters similar to those of Application Example 1, both of Application Example 8 in which liquid repellency was imparted to outer wall surface 20b of inner tubular portion 20 on the outer side and Application Example 9 in which liquid repellency was imparted to inner wall surface 30a of outer tubular portion 30 obtained the evaluation that “excellent adhesion suppression performance is exhibited”.

From results of Application Example 8-9, it was found that by imparting liquid repellency to outer wall surface 20b of inner tubular portion 20 on the outer side or inner wall surface 30a of outer tubular portion 30 of the flow reactor, a more stable segment flow can be formed in production of fine particles, and excellent adhesion suppression performance is exhibited.

Note that in Application Example 8-9, liquid repellency is imparted to one of outer wall surface 20b of inner tubular portion 20 on the outer side and inner wall surface 30a of outer tubular portion 30, but the present disclosure is not limited to this. It is considered that flow reactor 1 can be produced so as to impart liquid repellency to both outer wall surface 20b of inner tubular portion 20 on the outer side and inner wall surface 30a of outer tubular portion 30, and by imparting liquid repellency to both outer wall surface 20b of inner tubular portion 20 on the outer side and inner wall surface 30a of outer tubular portion 30, a more stable segment flow is formed, and excellent adhesion suppression performance is obtained.

As described above, the accompanying drawings and the detailed description are provided to describe the exemplary embodiment of the technique in the present disclosure. Thus, components described in the accompanying drawings and the detailed description may include not only components essential for solving the problem, but also components non-essential for solving the problem to describe the above techniques. For this reason, it should not be immediately recognized that these non-essential components are essential just because these non-essential components are described in the accompanying drawings and the detailed description.

According to one aspect of the present disclosure, it is possible to provide a flow reactor capable of suppressing adhesion of a product to a flow path.

The present disclosure is applicable to fine particle production using microflow synthesis. The present disclosure is applicable to, for example, production of various inorganic particles, polymers, proteins, or the like. The present disclosure can also be applied to a mixer for recycling raw materials in which elements dissolved in a solvent are precipitated and collected as a solid component.

What is claimed is:

1. A flow reactor for mixing a first fluid and a second fluid, the flow reactor comprising:
an outer tubular portion in which a plurality of fluids flow from an upstream end to a downstream end in a flow direction;
a first inner tubular portion disposed in a part of an inside of the outer tubular portion and fluidly communicating with the outer tubular portion at a first tip of the first inner tubular portion; and
a second inner tubular portion disposed in a part of the inside of the first inner tubular portion and fluidly communicating with the first inner tubular portion at a second tip of the second inner tubular portion, wherein
the first fluid flows toward the first tip in the flow direction between an inner wall of the first inner tubular portion and an outer wall of the second inner tubular portion, the second fluid flows toward the second tip in the flow direction inside the second inner tubular portion,
a third fluid having low affinity for the first fluid and the second fluid flows toward the downstream end in the flow direction between an outer wall of the first inner tubular portion and an inner wall of the outer tubular portion, and
the second tip does not protrude further to a side of the downstream end than the first tip, and the first tip is located closer to a side of the upstream end than the downstream end when viewed from a direction orthogonal to the flow direction.

2. The flow reactor according to claim 1, wherein
a gap is provided between the first tip and the second tip when viewed from a direction orthogonal to the flow direction, and
0 mm≤d<50 mm is satisfied, where d denotes a length of the gap along the flow direction.

3. The flow reactor according to claim 1, wherein an outer wall surface of the first inner tubular portion has liquid repellency.

4. The flow reactor according to claim 1, wherein an inner diameter of the first inner tubular portion ranges from 0.5 mm to 20 mm inclusive.

5. The flow reactor according to claim 1, wherein an inner wall surface of the outer tubular portion has liquid repellency.
